(19) United States
(12) Patent Application Publication
(10) Pub. No.: US 2024/0407363 A1
(43) Pub. Date: Dec. 12, 2024

(54) NOVEL COMPOUNDS FOR MANAGEMENT OF BACTERIAL SPOT DISEASE IN TOMATO

(71) Applicant: University of Florida Research Foundation, Inc., Gainesville, FL (US)

(72) Inventors: Shouan ZHANG, Homestead, FL (US); Jeffrey B. JONES, Gainesville, FL (US); Qingchun LIU, Palmetto Bay, FL (US); Ketsira PIERRE, Lake Park, FL (US); Mustafa O. JIBRIN, Gainesville, FL (US); Naweena THAPA, Elkton, MD (US)

(21) Appl. No.: 18/689,470

(22) PCT Filed: Sep. 15, 2022
(86) PCT No.: PCT/US2022/076448

§ 371 Date: Mar. 6, 2024

Related U.S. Application Data
(60) Provisional application No. 63/244,461, filed on Sep. 15, 2021.

(51) Int. Cl. A01N 43/40; A01N 37/02; A01N 43/36; A01P 1/00

(52) U.S. Cl. CPC A01N 43/40; A01N 37/02; A01N 43/36; A01P 1/00

(57) ABSTRACT

Described herein are small molecules, compositions, methods, and kits relating to the treatment of bacterial spot disease in plants, in particular in tomato. In certain aspects, described herein is a small molecule composition for the treatment of bacterial spot disease or bacterial speck disease in a subject in need thereof, comprising piperidine, pyrrolidine, hexanoic acid, or any combination thereof, present in an amount to treat the symptoms of bacterial spot disease or bacterial speck disease in a subject in need thereof. Further described herein are methods of use and kits comprising the same.

### CROSS-REFERENCE TO RELATED APPLICATION [S]

This application claims priority to and the benefit of U.S. Provisional Application entitled “NOVEL COMPOUNDS FOR MANAGEMENT OF BACTERIAL SPOT DISEASE IN TOMATO,” having Ser. No. 63/244,461, filed on Sep. 15, 2021, which is entirely incorporated herein by reference.

### GOVERNMENT SUPPORT

This invention was made whole or in part through a grant awarded by the United States Department of Agriculture, Agricultural Marketing Services to the State of Florida, Department of Agricultural and Consumer Services and provided for this project under a subrecipient award.

### BACKGROUND

Managing bacterial spot in plants such as tomato remains one of the greatest challenges to tomato growers in tomato production. Practically, bacterial spot management largely relies on application of fixed copper-based bactericides. However, control by copper-based compounds is often marginal or ineffective in climates such as Florida, where foggy mornings are common and due to widespread presence of copper-resistant strains of the pathogen. Furthermore, accumulation of copper in the environment is a major concern for excessive use of copper-based products in agriculture.

Additionally, seed used for tomato seedlings have to be pathogen-free. Seed treatments have been used to eliminate seedborne bacterial pathogens, but they are insufficient to eliminate disease development in the field. Host plant resistance is a very useful strategy of plant disease control. However, resistance to bacterial spot disease is still not available in commercial tomato cultivars because of frequent changes in the Xanthomonas pathogen along with quantitative resistance in the host plant, which is more difficult to manipulate than single qualitative genes. To date, breeding programs have been largely unsuccessful in developing acceptable tomato varieties that are durably resistant to bacterial spot.

Accordingly, there is a need to address the aforementioned deficiencies and inadequacies.

### SUMMARY

Described herein are compositions, methods, and kits for the treatment of diseases in plants, for example bacterial spot disease and bacterial speck disease, in plants such as tomato and pepper plants.

In embodiments, described herein is a small molecule composition for the treatment of bacterial spot disease (or bacterial speck disease) in a subject in need thereof, comprising: piperidine, pyrrolidine, hexanoic acid, or any combination thereof. In certain aspects, then the piperidine, pyrrolidine, hexanoic acid, or combination thereof, is present in an amount to treat the symptoms of bacterial spot disease or bacterial speck disease in a subject in need thereof.

In embodiments, the subject in need thereof is a plant infected or at risk for infection by a bacterium of the Xanthomonas genus or Pseudomonas syringae pv. tomato. In embodiments, the plant is a plant of the species Solanum lycopersicum or Capsicum anuum. In embodiments, the bacterium of the Xanthomonas genus is X. vesicatoria, X. perforans, X. euvesicatoria, or X. gardneri. In an embodiment, the bacterium is of the Xanthomonas genus and is X. perforans. In embodiments, the effective amount is a concentration of about 4 mg/L to about 1024 mg/L. In embodiments, the effective amount is a concentration of about 512 mg/L. In embodiments, the composition comprises hexanoic acid at a concentration of about 512 mg/L.

In embodiments, described herein is a small molecule composition for the treatment of bacterial spot disease (or bacterial speck disease) in a subject in need thereof, comprising: piperidine, pyrrolidine, hexanoic acid, or any combination thereof; and an aqueous vehicle. In embodiments, the piperidine, pyrrolidine, or hexanoic acid is present in an amount to treat the symptoms of bacterial spot disease or bacterial speck disease in a subject in need thereof. In embodiments, the subject in need thereof is a plant infected or at risk for infection by a bacterium of the Xanthomonas genus or Pseudomonas syringae pv. tomato. In embodiments, the plant is a plant of the species Solanum lycopersicum or Capsicum annuum. In embodiments, the bacterium of the Xanthomonas genus is X. vesicatoria, X. perforans, X. euvesicatoria, or X. gardneri. In embodiments, the bacterium of the Xanthomonas genus is X. perforans. In embodiments, the effective amount is a concentration of about 4 mg/L to about 1024 mg/L. In embodiments, the effective amount is a concentration of about 512 mg/L. In embodiments, the composition comprises hexanoic acid at a concentration of about 512 mg/L. In embodiments, the aqueous vehicle is water. In embodiments, compositions as described herein further comprise a copper-based bactericide. In embodiments, the copper-based bactericide is present in an effective amount to treat the symptoms of bacterial spot disease or bacterial speck disease in a subject in need thereof. In embodiments, the effective amount of copper-based bactericide is about 1 g/L to about 2.1 g/L. In embodiments, the copper-based bactericide is CuSO₄, a copper hydroxide, a Kocide®, a ManKocide®, or Kocide®+Penncozeb®.

Described herein are methods of treating or preventing bacterial spot disease or bacterial speck disease in a subject in need thereof, comprising administering a small molecule composition to the subject in need thereof. In embodiments of methods as described herein, the small molecule composition comprises: piperidine, pyrrolidine, hexanoic acid, or any combination thereof. In embodiments of methods as described herein, the small molecule composition further comprises an aqueous vehicle. In embodiments of methods as described herein, the piperidine, pyrrolidine, or hexanoic acid is present in an amount to treat the symptoms of bacterial spot disease or bacterial speck disease in a subject in need thereof. In embodiments of methods as described herein, the subject in need thereof is a plant infected or at risk for infection by a bacterium of the Xanthomonas genus or Pseudomonas syringae pv. tomato. In embodiments of methods as described herein, the plant is a plant of the species Solanum lycopersicum or Capsicum annum. In embodiments of methods as described herein, the bacterium of the Xanthomonas genus is X. vesicatoria, X. perforans, X. euvesicatoria, or X. gardneri. In embodiments of methods as described herein, the bacterium of the Xanthomonas genus is X. perforans. In embodiments of methods as described herein, the effective amount is a concentration of about 4 mg/L to about 1024 mg/L. In embodiments of methods as described herein, the effective amount is a concentration of about 512 mg/L. In embodiments of methods as described herein, the small molecule composition comprises hexanoic acid at a concentration of about 512 mg/L. In embodiments of methods as described herein, the aqueous vehicle is water. In embodiments of methods as described herein, a small molecule composition further comprises a copper-based bactericide. In embodiments of methods as described herein, the copper-based bactericide is present in an effective amount to treat the symptoms of bacterial spot disease or bacterial speck disease in a subject in need thereof. In embodiments of methods as described herein, the effective amount of copper-based bactericide is about 1 g/L to about 2.1 g/L. In embodiments of methods as described herein, the copper-based bactericide is CuSO₄, a copper hydroxide, a Kocide®, a ManKocide®, or Kocide®+Penncozeb®.

Described herein are kits. In embodiments, described herein is a kit for applying a small molecule composition for the treatment of bacterial spot disease or bacterial speck disease in a subject in need thereof, comprising: piperidine, pyrrolidine, hexanoic acid, or any combination thereof; an aqueous vehicle; and an applicator. In embodiments of kits as described herein, the piperidine, pyrrolidine, or hexanoic acid is present in an amount to treat the symptoms of bacterial spot disease or bacterial speck disease in a subject in need thereof. In embodiments of kits as described herein, the subject in need thereof is a plant infected or at risk for infection by a bacterium of the Xanthomonas genus or Pseudomonas syringae pv. tomato. In embodiments of kits as described herein, the plant is a plant of the species Solanum lycopersicum or Capsicum annuum. In embodiments of kits as described herein, the bacterium of the Xanthomonas genus is X. vesicatoria, X. perforans, X. euvesicatoria, or X. gardneri. In embodiments of kits as described herein, the bacterium of the Xanthomonas genus is X. perforans. In embodiments of kits as described herein, the effective amount is a concentration of about 4 mg/L to about 1024 mg/L. In embodiments of kits as described herein, the effective amount is a concentration of about 512 mg/L. In embodiments of kits as described herein, the small molecule composition comprises hexanoic acid at a concentration of about 512 mg/L. In embodiments of kits as described herein, the aqueous vehicle is water. In embodiments of kits as described herein, the small molecule composition further comprises a copper-based bactericide. In embodiments of kits as described herein, the copper-based bactericide is present in an effective amount to treat the symptoms of bacterial spot disease or bacterial speck disease in a subject in need thereof. In embodiments of kits as described herein, the effective amount of copper-based bactericide is about 1 g/L to about 2.1 g/L. In embodiments of kits as described herein, the copper-based bactericide is CuSO₄, a copper hydroxide, a Kocide®, a ManKocide®, or Kocide®+Penncozeb®. In embodiments of kits as described herein, the applicator has at least one spray nozzle.

### BRIEF DESCRIPTION OF THE DRAWINGS

Many aspects of the disclosed devices and methods can be better understood with reference to the following drawings. The components in the drawings are not necessarily to scale, emphasis instead being placed upon clearly illustrating the relevant principles. Moreover, in the drawings, like reference numerals designate corresponding parts throughout the several views.

FIG. 1 is a graph showing in vitro results of piperidine (PI), copper, or control treatment subjected to X. perforans at 0, 1, 4, and 24 hr.

FIG. 2 is a graph showing in vitro results of piperidine (PI) or control treatment subjected to X. perforans at 0, 5, 15 min and 1 hr.

FIG. 3 is a graph showing in vitro results of pyrrolidine (PY), copper, or control treatment subjected to X. perforans at 0, 1, 4, and 24 hr.

FIG. 4 is a photograph showing culture plates screening for minimum bactericidal concentration (MBC) of X. perforans utilizing hexanoic acid (Hx) and copper (CuSO₄) treatments.

FIG. 5 is a photograph showing multi-well culture plates screening for minimum inhibitory concentration (MIC) of hexanoic acid (Hx) and copper (CuSO₄) treatments against X. perforans.

FIG. 6 is a graph of in vitro activity of Hx on X. perforans population at different time points with control or various concentrations (mg/L) of hexanoic acid treatment, plotting bacterial population (GEV-485 strain) against treatment (error bars are standard deviation).

FIG. 7 is a photograph showing a tomato plant as utilized in the in planta greenhouse experiments of the present disclosure, where the soil was drenched with 50 mL of control or treatment solution.

FIGS. 8A-8B are photographs of tomato leaves showing bacterial spot lesions caused by X. perforans bacterial infection.

FIG. 9 is a plot of preliminary greenhouse screening showing the effect (preliminary AUDPC) of control (UTC), hexanoic acid, Kocide® 3000, or Kocide®3000+Penncozeb® combinatorial treatment against the development of bacterial spots on tomato plants in planta. A concentration of 512 mg/L for hexanoic acid was used and error bars represent standard deviation.

FIG. 10 is a plot of AUDPC vs. treatment showing the effect of hexanoic acid on the development of tomato bacterial spot in planta in the greenhouse. Error bars are standard deviation. At different treatment concentrations, application of hexanoic acid at two days prior to the bacterial inoculation resulted in statistically significant (p<0.05) lower disease severity than the control (UTC) over a two-week rating period.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limits of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of plant science, plant pathology, botany, bacteriology, microbiology, molecular biology, organic chemistry, and biochemistry.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amount, temperature, etc.), but some errors and deviations should be accounted for. Unless indicated otherwise, parts are parts by weight, temperature is in ° C., and pressure is in atmosphere. Standard temperature and pressure are defined as 25° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

### Definitions

Unless otherwise defined, all technical and scientific terms used herein have the same meaning as commonly understood by one of ordinary skill in the art of molecular biology, medicinal chemistry, and/or organic chemistry. Although methods and materials similar or equivalent to those described herein can be used in the practice or testing of the present disclosure, suitable methods and materials are described herein.

As used in the specification and the appended claims, the singular forms “a,” “an,” and “the” may include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, a “subject” can be a member of the Solanum lycopersicum (S. lycoperisum, i.e. tomato) or Capsicum annuum (C. annuum, i.e. pepper) species of plants. In certain embodiments, a subject is a plant of the Solanum lycopersicum species. In certain embodiments, a subject is a plant of the Capsicum annuum species. A “subject in need thereof” can be a subject as described herein (a plant of the Solanum lycopersicum species) that is subjected to, or at risk for, bacterial spot infection. In certain embodiments, a “subject in need thereof” is a plant (a plant of the Solanum lycopersicum species) that is subjected to, or at risk for, infection by a bacterium of the genus Xanthomonas (for example, X. vesicatoria, X. perforans, X. euvesicatoria, and X. gardneri).

As used herein, “bactericide” or can refer to a compound as described herein that can kill bacteria or reduce the symptoms of bacterial infection in a plant.

As used herein, “control” is an alternative subject or sample used in an experiment for comparison purposes and included to minimize or distinguish the effect of variables other than an independent variable.

As used herein, “wild-type” is the typical form of an organism, variety, strain, gene, protein, or characteristic as it occurs in nature, as distinguished from mutant forms that may result from selective breeding or transformation with a transgene.

As used herein, “culturing” refers to maintaining plants (or cells thereof) under conditions in which they can proliferate, for example in vitro or in planta. “Culturing” can also include conditions in which the cells also or alternatively differentiate.

As used herein, “organism”, “host”, and “subject” refers to any living entity comprised of at least one cell as described herein (for example a plant or constituent thereof). A living organism can be as simple as, for example, a single isolated eukaryotic cell or cultured cell or cell line, or as complex as an entire plant (or a constituent or isolated constituent thereof, for example a leaf or root). “Subject” may also be a cell, a population of cells, an entire plant, and constituents thereof.

As used herein, “non-naturally occurring” refers to a form of a molecule or compound that is not found in nature or expected to be found in nature. This can include where a compound is present in a certain amount or form that is not found in nature.

As used herein, “about” can encompass values that deviate from the reference value by ±0.1%-10%.

### DISCUSSION

Tomato is an economically important vegetable crop in the USA and worldwide. The total crop value of tomato in the USA was over $1.8 billion in 2018 according to USDA NASS (2019). Fresh market tomato is the most important vegetable in Florida with a total value of $336.5 million on 27,000 acres harvested in 2018. Bacterial spot of tomato, caused by at least four species of Xanthomonas (X. vesicatoria, X. perforans, X. euvesicatoria, and X. gardneri), is one of the most economically important diseases in tomatoes. In Florida, X. perforans is the main pathogen of bacterial spot on tomato and all X. perforans isolates collected Florida tomato fields are copper resistant strains. Warm and wet conditions favor this disease development, particularly when the temperatures range from 24 to 30° C., which is common during the growing season in Florida. In the field, X. perforans bacteria are primarily spread by wind-driven rain, irrigation water through over-head sprinklers, and the clipping of tomato transplants. Infection of tomato seedlings is destructive and can result in entire crop loss. It is estimated that, due to bacterial spot, losses in tomato production in southwest Florida was $3,090 per acre based on 2007-2008 production costs and costs in this region.

Managing bacterial spot of tomato remains one of the greatest challenges to tomato growers in tomato production. Practically, bacterial spot management largely relies on application of fixed copper-based bactericides. However, control by copper-based compounds is often marginal or ineffective in Florida, where foggy mornings are common and due to widespread presence of copper-resistant strains of the pathogen. Furthermore, accumulation of copper in the environment is a major concern for excessive use of copper-based products in agriculture. Seed used for tomato seedlings have to be pathogen-free. Seed treatments have been used to eliminate seedborne bacterial pathogens, but they are insufficient to eliminate disease development in the field. Host plant resistance is a very useful strategy of plant disease control. However, resistance to bacterial spot is still not available in commercial tomato cultivars because of frequent changes in the Xanthomonas pathogen along with quantitative resistance in the host plant, which is more difficult to manipulate than single qualitative genes. To date, breeding programs have been largely unsuccessful in developing acceptable tomato varieties that are durably resistant to bacterial spot.

Small molecules with a molecular weight less than 900 Daltons have been investigated for their potential as bactericides for controlling bacterial spot in tomato. Results from in vitro assays and in planta experiments show that small molecules tested can be effective in suppressing copper-resistant X. perforans growth and reducing the disease. Field experiments conducted with some of the small molecules indicate that these compounds can be used for control of bacterial spot of tomato under field conditions.

### Plant Species

Described herein are small molecules, compositions, methods, and kits suitable for use on plants according to the present disclosure that have been infected by (or subject to infection by) pathogens according to the present disclosure.

In embodiments according to the present disclosure, plants are those of the species Solanum lycopersicum (i.e. tomato) or Capsicum annuum (i.e. pepper).

### Pathogens

Bacterial spot disease in plants (for example tomatoes) can be caused by a bacterial pathogen, for example a pathogen of the genus Xanthomonas. Further examples of bacterial pathogens according to the present disclosure include, for example, the Xanthomonas species X. vesicatoria, X. perforans, X. euvesicatoria, and X. gardneri, in particular X. perforans.

In further examples, pathogens as described herein can be those of Pseudomonas syringae pv. tomato (Pst), responsible for causing disease such as bacterial speck disease in tomato.

Small molecules, compositions, methods, and kits according to the present disclosure can be effective to reduce an amount of pathogen on, in, or around a plant as described herein, or effective to reduce symptoms of plant infection by a pathogen as described herein.

### Small Molecules, Effective Amounts, and Compositions Thereof

Described herein are small molecules (molecules with a molecular weight of less than 900 Da), and compositions thereof, that can be effective for the treatment of bacterial spot disease in plants (for example tomato).

In an embodiment according to the present disclosure, a small molecule is piperidine (also referred to herein as PI) having the structure:

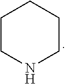

In an embodiment according to the present disclosure, a small molecule is pyrrolidine (also referred to herein as PY) having the structure:

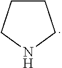

In an embodiment according to the present disclosure, a small molecule is hexanoic acid (also known as caproic acid, and also referred to herein as Hx) having the structure:

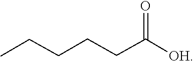

Further embodiments of small molecules according to the present disclosure include 2,6-Dipiperidino-4-bromochlorobenzene, 2,6-Dipiperidino-4-bromoiodobenzene, 2,4,6-Tripyrrolidinochlorobenzene, and 2,6-Dipyrrolidino-1,4-dibromobenzene.

According to the present disclosure, small molecules can be present in an effective amount (or amount effective) to reduce symptoms of bacterial spot disease in a subject in need thereof (plants, for example tomato and pepper). According to the present disclosure, small molecules can be present in an effective amount (or amount effective) to reduce bacteria (for example a bacterium of the genus Xanthomonas, like X. perforans) in, on, or around a subject in need thereof (plants, for example tomato).

In embodiments according to the present disclosure, an effective amount is a concentration of about 4 mg/L to about 1024 mg/L; about 32 mg/L to about 512 mg/L; about 64 mg/L to about 256 mg/L; or about 128 mg/L. In other embodiments, an effective amount is a concentration of about 10 mg/L to about 1000 mg/L; about 20 mg/L to about 990 mg/L; about 30 mg/L to about 980 mg/L; about 40 mg/L to about 980 mg/L; about 50 mg/L to about 970 mg/L; about 60 mg/L to about 960 mg/L; about 70 mg/L to about 950 mg/L; about 80 mg/L to about 940 mg/L; about 90 mg/L to about 930 mg/L; about 100 mg/L to about 930 mg/L; about 110 mg/L to about 920 mg/L; about 120 mg/L to about 910 mg/L; about 130 mg/L to about 900 mg/L; about 140 mg/L to about 890 mg/L; about 150 mg/L to about 880 mg/L; about 160 mg/L to about 870 mg/L; about 170 mg/L to about 860 mg/L; about 180 mg/L to about 850 mg/L; about 190 mg/L to about 840 mg/L; about 200 mg/L to about 830 mg/L; about 210 mg/L to about 820 mg/L; about 220 mg/L to about 810 mg/L; about 230 mg/L to about 800 mg/L; about 240 mg/L to about 790 mg/L; about 250 mg/L to about 780 mg/L; about 260 mg/L to about 770 mg/L; about 270 mg/L to about 760 mg/L; about 280 mg/L to about 750 mg/L; about 280 mg/L to about 740 mg/L; about 290 mg/L to about 730 mg/L; about 300 mg/L to about 720 mg/L; about 310 mg/L to about 710 mg/L; about 320 mg/L to about 700 mg/L; about 330 mg/L to about 690 mg/L; about 340 mg/L to about 680 mg/L; about 350 mg/L to about 670 mg/L; about 360 mg/L to about 660 mg/L; about 370 mg/L to about 650 mg/L; about 380 mg/L to about 640 mg/L; about 390 mg/L to about 630 mg/L; about 400 mg/L to about 620 mg/L; about 410 mg/L to about 610 mg/L; about 420 mg/L to about 600 mg/L; about 430 mg/L to about 590 mg/L; about 440 mg/L to about 580 mg/L; about 450 mg/L to about 570 mg/L; about 460 mg/L to about 560 mg/L; about 470 mg/L to about 550 mg/L; about 480 mg/L to about 540 mg/L; about 470 mg/L to about 530 mg/L; about 480 mg/L to about 520 mg/L; about 80 mg/L to about 940 mg/L; about 490 mg/L to about 510 mg/L; or about 500 mg/L.

In embodiments, an effective about is a concentration of about 32 mg/L. In embodiments, an effective amount is a concentration of about 64 mg/L. In embodiments, an effective amount is about 128 mg/L. In embodiments, an effective amount is about 512 mg/L. In embodiments, and effective amount is about 1024 mg/L. It is noted that according to the present disclosure, 1 mg/L=1 μg/mL=1 ppm. In embodiments, an effective amount is a concentration of about 0.5 mg/mL.

Described herein are also compositions comprising small molecules according to the present disclosure. In embodiments, compositions according to the present disclosure contain an effective amount of a small molecule according to the present disclosure. In embodiments, compositions as described herein can be aqueous compositions. In embodiments, compositions as described herein can comprise small molecules according to the present disclosure in an aqueous vehicle, such as water.

In certain embodiments, compositions as described herein can further comprise a copper-based bactericide (for example CuSO₄, a copper hydroxide, a Kocide®, a ManKocide®, or Kocide®+Penncozeb®). As used herein, Kocide® can also refer to Kocide®3000. In such synergistic compositions, a small molecule as described herein can be present in a concentration of about 32 mg/L to about 128 mg/L and the copper-based bactericide can be present in an amount of about 1 g/L to about 2.1 g/L. In embodiments, the copper-based bactericide can be present in an amount of about 1 g/L.

In such synergistic compositions, a small molecule as described herein can be present in a concentration of about 32 mg/L to about 128 mg/L; about 40 mg/L to about 120 mg/L; about 50 mg/L to about 110 mg/L; about 60 mg/L to about 100 mg/L; about 70 mg/L to about 90 mg/L; or about 80 mg/L; and the copper-based bactericide can be present in an amount of about 1 g/L to about 2.1 g/L; about 1.1 g/L to about 2 g/L; about 1.2 g/L to about 1.9 g/L; about 1.3 g/L to about 1.8 g/L; about 1.4 g/L to about 1.7; and about 1.5 g/L to about 1.6 g/L.

### Methods

Described herein are methods of use and treating subjects in need thereof. Methods according to the present disclosure can comprise providing an effective amount to a subject in need thereof. Methods as described herein can include providing the effective amount as a soil drench (at or around the base of the plant) and/or foliar spray on the leaves of the plant. Methods as described herein can include administering the effective amount once for a period of one to fifty-six (56) days; one to 55 days; one to 54 days; one to 53 days; one to 52 days; one to 51 days; one to 50 days; one to 49 days; one to 48 days; one to 47 days; one to 46 days; one to 45 days; one to 45 days; one to 44 days; one to 43 days; one to 42 days; one to 41 days; one to 40 days; one to 39 days; one to 38 days; one to 37 days; one to 36 days; one to 35 days; one to 34 days; one to 33 days; one to 32 days; one to 31 days; one to 30 days; one to 29 days; one to 28 days; one to 27 days; one to 26 days; one to 25 days; one to 24 days; one to 23 days; one to 22 days; one to 21 days; one to 20 days; one to 19 days; one to 18 days; one to 17 days; one to 16 days; one to 15 days; one to 14 days; one to 13 days; one to 12 days; one to 11 days; one to 10 days; one to 9 days; one to 8 days; one to 7 days; one to 6 days; one to 5 days; one to 4 days; one to 4 days; one to 3 days; or one to 2 days.

In embodiments, methods can be administered once. In embodiments, methods can be administered once daily for eight weeks (or fifty-six days); one daily for seven weeks; once daily for five weeks, once daily for four weeks, once daily for three weeks; once daily for two weeks; or once daily for one week.

### Applicators/Kits

Described herein are bactericidal kits. In embodiments of bactericidal kits described herein, a bactericidal kit can comprise a bactericide, or bactericidal composition as described herein, and an applicator. In embodiments of bactericidal kits described herein, the applicator can be an aerosol spray can, a pump-spray bottle, a fogger can, a handheld sprayer, a backpack sprayer, and the like. In embodiments of bactericidal kits described herein, the bactericidal kit comprises an effective amount of bactericides to reduce the number of Xanthomonas bacteria on or around a plant as described herein or symptoms of bacterial spot disease (such as lesions) on a plant as described herein.

In embodiments, applicators can be spray bottles. In embodiments, applicators can have at least one spray nozzle that is capable of turning aqueous compositions as described herein into aerosols.

While embodiments of the present disclosure are described in connection with the Examples and the corresponding text and figures, there is no intent to limit the disclosure to the embodiments in these descriptions. On the contrary, the intent is to cover all alternatives, modifications, and equivalents included within the spirit and scope of embodiments of the present disclosure.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

### Embodiment of a Protocol for Evaluating Effects of Piperidine and Pyrrolidine In-Vitro Against X. perforans

X. perforans strain: Copper-resistant strain GEV 485 was used.

Bacterial Suspension: GEV 485 from −80° C. was streaked onto a nutrient agar (NA) plate and incubated at 28° C. for 48 hours for single colonies. Single colonies were streaked onto a Cu-amended NA plate to confirm copper tolerance. Plate was incubated for 24 hours at 28° C. To make the bacterial suspension for inoculation, bacterial cells from the Cu-amended plate were resuspended in sterile water to the concentration of 5×10⁸ CFU/mL (A₆₀₀=0.3). The final concentration of the suspension was adjusted with water to 5×10⁵ CFU/mL. Then 20 μL of the bacterial suspension was added to the test tube containing different concentrations of the small molecules. Preparation of Piperidine and Pyrrolidine Solutions: Piperidine and pyrrolidine were dissolved in water to the test concentrations desired in the assays. Different compounds were added to different test tubes and diluted with sterile water for the desired test concentrations. Final volume of each test tube containing chemical solutions (compound+sterile water) was 2 mL. Controls included the tubes containing 2 mL of CuSO₄ solutions at the same concentration of compound solutions and the tubes containing 2 mL sterile water only.

In vitro Assays: 20 μL of the X. perforans suspension was added to each tube containing 2 mL of compound solutions. All tubes were then incubated at 28° C. on an orbital shaker at 150 rpm. Samples of 50 μL of solution (small molecule+ bacterial suspension) were taken after 0 h, 1 h, 4 h, and 24 h. The bacterial suspensions were diluted serially and 50 μL of dilutions at appropriate concentrations were plated onto NA plates. The plates were incubated for 48 h when bacterial colonies of X. perforans were counted. Each treatment consisted of 3 replicates and the experiment was conducted twice.

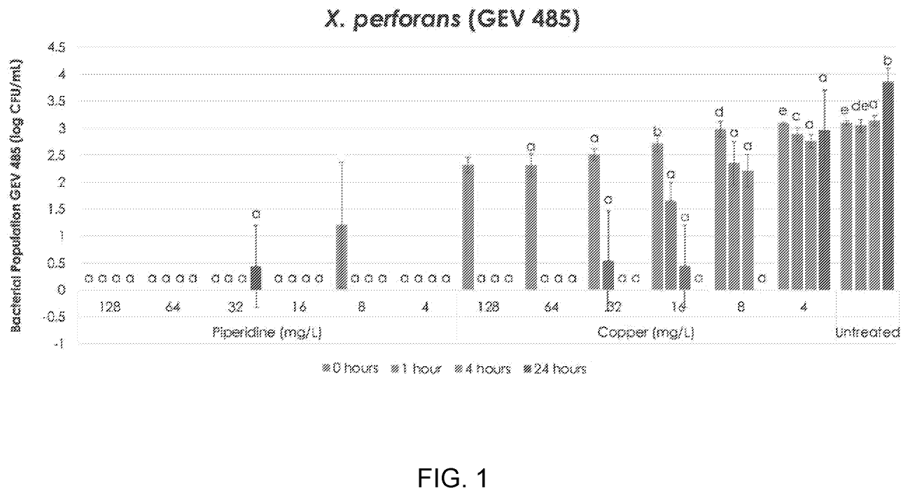

Results: FIG. 1 is a graph showing in vitro results of piperidine (PI), copper, or control treatment subjected to X. perforans during a period of 24 h.

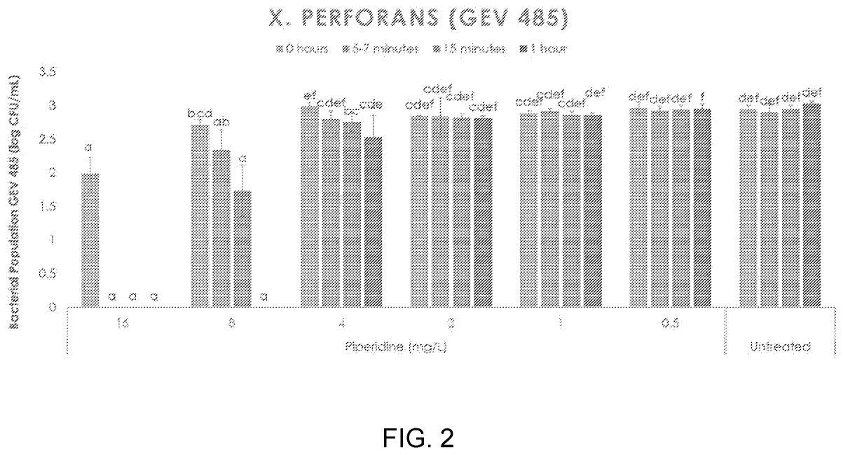

FIG. 2 is a graph showing in vitro results of piperidine (PI) or control treatment subjected to X. perforans during a period of 1 h.

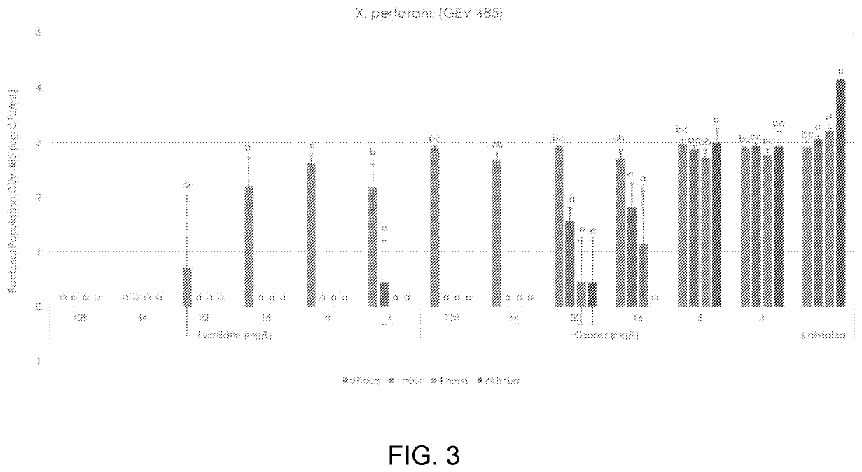

FIG. 3 is a graph showing in vitro results of pyrrolidine (PY), copper, or control treatment subjected to X. perforans during a period of 24 h.

Data is plotted as bacterial population (X. perforans strain GEV 485) log CFU/mL against treatment.

### Example 2

### Greenhouse Experiment Using Piperidine (PI) and Pyrrolidine (PY)

### Materials and Methods

Tomato (cv. FL 47) was seeded in the greenhouse (the highest temperature was set at 82° F.) and the seedlings with two fully expanded leaves (about 3 weeks after seeding) were transplanted to soilless mix in 6-inch pots. One week after transplanting, treatments with the compounds at the test concentrations were sprayed onto plants until runoff approx. 2 h before inoculation with X. perforans. Untreated plants were used as the control (CK). There were five plants in each treatment and one plant served as one replicate. All plants were inoculated by spraying a bacterial suspension of X. perforans (a copper-resistant strain QL) at 1×10⁸ CFU/ml until runoff. Inoculated plants were incubated in a moist chamber overnight (approx. 18 h) to ensure and promote infection by X. perforans. Then the inoculated plants were taken out and placed randomly on a bench inside the greenhouse for disease development. Plants were sprayed with mist periodically to stimulate disease development. When lesions on the leaves were apparent, the percentage of leaf area covered by the lesions, either for the two mostly infected leaves or the whole plant, was rated and recorded for each treatment. Disease rating was conducted at least two times. The area under the disease progress curve (AUDPC) was calculated for each treatment to reflect the disease development over a period if disease rating was carried out three times or more.

Pyrrolidine (PY) at 64 and 128 mg/L each, in a statistical sense, significantly (P<0.05) reduced bacterial spot disease compared to the untreated control (CK).

Piperidine at 32 and 64 mg/L alone failed to reduce the disease compared to CK. However, PI64+K1.0—Piperidine at 64 mg/L (PI64) applied with Kocide® 3000 at 1.0 g/L (=0.87 lb/acre) (K1.0) significantly improved efficacy of K1.0 alone, equivalent to Kocide® at the highest label rate (K2.1, 2.1 g/L=1.75 lb/acre).

TABLE 1
Greenhouse Treatment of Bacterial Spot in Tomato using Piperidine (PI) and Pyrrolidine (PY)

| | 10 d | 12 d | 14 d | 10 d | 12 d | 14 d | | |
|---|---|---|---|---|---|---|---|---|
| trt | BS1 | BS2 | BS3 | WHOLE1 | WHOLE2 | WHOLE3 | AUDPC_BS | AUDPC_WHOLE |
| CK | 22.0 ab | 30.0 a | 35.0 b | 11.0 ab | 14.0 bcd | 17.0 b | 409.5 b | 196.0 c |
| K2.1 | 6.0 c | 5.0 c | 7.2 c | 1.5 c | 1.4 e | 1.7 d | 81.2 d | 21.0 d |
| K1.0 | 23.5 a | 29.0 a | 37.0 b | 10.0 ab | 20.2 ab | 24.2 ab | 414.8 b | 261.1 abc |
| PI32 | 24.5 a | 33.0 a | 35.0 b | 14.2 a | 26.0 ab | 26.0 ab | 439.3 b | 322.7 ab |
| PI64 | 30.0 a | 36.0 a | 54.0 a | 10.0 ab | 28.0 a | 32.0 a | 546.0 a | 343.0 a |
| PY64 | 14.0 bc | 15.2 bc | 17.5 c | 5.1 bc | 7.5 cde | 5.3 c | 219.6 c | 88.7 d |
| PY128 | 7.5 c | 9.0 c | 11.0 c | 1.5 c | 1.8 de | 3.8 c | 127.8 cd | 31.2 d |
| PI32 + K1.0 | 21.5 ab | 26.0 ab | 39.0 b | 8.0 ab | 18.0 abc | 22.0 ab | 393.8 b | 231.0 bc |
| PI64 + K1.0 | 4.8 c | 8.0 c | 15.7 c | 0.9 c | 1.8 de | 5.1 c | 127.8 cd | 33.6 d |
| PY64 + K1.0 | 14.0 bc | 14.0 bc | 12.5 c | 4.8 bc | 5.2 de | 3.8 c | 190.8 c | 66.5 d |
| PY128 + K1.0 | 9.5 c | 9.5 c | 12.0 c | 1.3 c | 5.8 cde | 2.0 c | 141.8 cd | 52.2 d |
| LSD0.05 | 9.4 | 12.5 | 14.9 | 6.4 | 12.3 | 11.7 | 99.8 | 91.9 |

Key to abbreviations for Table 1:
CK—untreated control
K2.1—Kocide ® 3000 (copper hydroxide) at label rate = 2.1 g/L (1.75 lb/acre)
K1.0—Kocide ® 3000 at a half label rate = 1.0 g/L (0.87 lb/acre)
PI32—Piperidine at 32 mg/L = 32 ppm
PI64—Piperidine at 64 mg/L = 64 ppm
PY64—Pyrrolidine at 64 mg/L = 64 ppm
PY128—Pyrrolidine at 128 mg/L = 128 ppm
PI32 + K1.0—Piperidine at 32 ppm applied in combination with Kocide ® 3000 at 1.0 g/L
PI64 + K1.0—Piperidine at 64 ppm applied in combination with Kocide ® 3000 at 1.0 g/L
PY64 + K1.0—Pyrrolidine at 64 ppm applied in combination with Kocide ® 3000 at 1.0 g/L
PY128 + K1.0—Pyrrolidine at 128 ppm applied in combination with Kocide ® 3000 at 1.0 g/L
BS1, BS12, BS14—Average of disease severity of bacterial spot on two mostly infected leaves 10, 12, 14 days after inoculation with X. perforans, respectively.
WHOLE1, WHOLE2, WHOLE3—the disease severity over the whole plant at 10, 12, 14 days after inoculation with X. perforans, respectively.
AUDPC—Area of the disease development curve, calculated based on disease severity of bacterial spot over a period to reflect the overall disease development.
AUDPC_BS—AUDPC calculated based on disease severity of bacterial spot on two mostly infected leaves at 10, 12, 14 days after inoculation with X. perforans.
AUDPC_WHOLE—AUDPC calculated based on disease severity over the whole plant at 10, 12, 14 days after inoculation with X. perforans.

### Example 3

Hexanoic Acid Against X. perforans Strain GEV-485

### Materials and Methods

### Chemical

Hexanoic acid (Hx) (>99%, Sigma Aldrich) was tested for its effect on the management of bacterial leaf spot of tomato. Stock solutions of Hx (1.0×10⁴ mg/L) were prepared with sterile distilled water (SDW) and stored at 4° C. for further dilutions. Copper treatment suspensions were prepared using Kocide® 3000 (DuPont, Wilmington DE) that contains 30% metallic Cu in the form of copper hydroxide [Cu(OH)₂]. For greenhouse experiments, Kocide® 3000 at the rate of 2.1 g/L and Penncozeb 75DF (United Phosphorus Inc., King of Prussia, PA) at the rate of 1.2 g/L in SDW were prepared.

### In Vitro Assays

X. perforans strain GEV-485, a copper-resistant strain, was used in this study to evaluate the antibacterial activity of Hx. Working cultures of GEV-485 were retrieved from −80° C. storage vials containing bacterial suspensions in 30% glycerol (v/v). Bacterial cells were taken from the storage, streaked on nutrient agar (NA; Difco™ Sparks, MD) plates and incubated for 48 h at 28° C. and single colonies were picked and streaked on NA plates to ensure bacterial purity for further cultures. NA amended with copper (II) sulfate pentahydrate (CuSO₄·5H₂O) (Fisher Scientific-Hampton, NH) at 20 ppm, was used as copper tolerance selective agent. To prepare the bacterial inoculum, a single bacterial colony was streaked on NA and incubated for 24 h at 28° C. From those plates, loops of bacterial cells were collected and resuspended in SDW amended with 0.01 M MgSO₄. The bacterial concentration was adjusted to ˜5.0×10⁸ colony-forming units (CFU)/mL based on an optical density (OD) of 0.3 at 600 nm. The in vitro studies were conducted to determine the minimum inhibitory concentration (MIC), minimum bactericidal concentration (MBC), and the antibacterial activity at different time points.

To determine MIC of Hx against X. perforans GEV-485, individual 96-well plates containing 100 μL of nutrient broth (NB) with varied copper and Hx concentrations were inoculated with 100 μL of the GEV-485 suspension at the concentration of 1.0×10⁸ CFU/mL. The final chemical concentrations on the wells were 16, 32, 64, 128, 256, 512, 1024, 2048, 4096 and 8192 mg/L. Three wells with 100 UL of NB and 100 μL of the bacterial suspension were the controls. Solutions in all wells were thoroughly mixed by pipetting. The plate was, then, covered with a lid and incubated under stationary conditions at 28° C. for 24 h. The value of MIC for Hx and copper was determined as the minimum concentration (mg/L), at which the bacterial growth was inhibited (the solution was clear), among all tested concentrations of each chemical. After MIC was determined, an aliquot of 20 μL of the solution from the wells that gave a clear solution was plated on NA. The plates were incubated overnight at 28° C. to determine the MBC. The MBC was determined as the minimum concentration, at which >99.9% of the initial bacterial populations were killed and no visible growth of the bacterium was observed on the NA plates among all tested concentrations of antimicrobial agents. The experiment was repeated two more times, with three replications for each treatment.

For the antibacterial activity study of Hx at different time points, the bacterial suspension was prepared as described above. The final concentration of the suspension was adjusted to 1×10⁵ CFU/mL, and 20 μL of the suspension was added to tubes containing 2 mL of different concentrations of Hx as mentioned above. Additionally, three glass tubes of 2 mL SDW amended with 0.01 M MgSO₄ and 20 μL of the bacterial suspension served as the controls. All tubes were incubated at 28° C. on an orbital shaker at 150 rpm for the following times: 15 min, 1 h, 4 h, 8 h and 24 h. After incubation, 50 μL from each tube was plated on NA medium and incubated at 28° C. for 48 h. After incubation, total viable colonies for each tube were counted. Each treatment consisted of three replicates and the experiment was repeated two times.

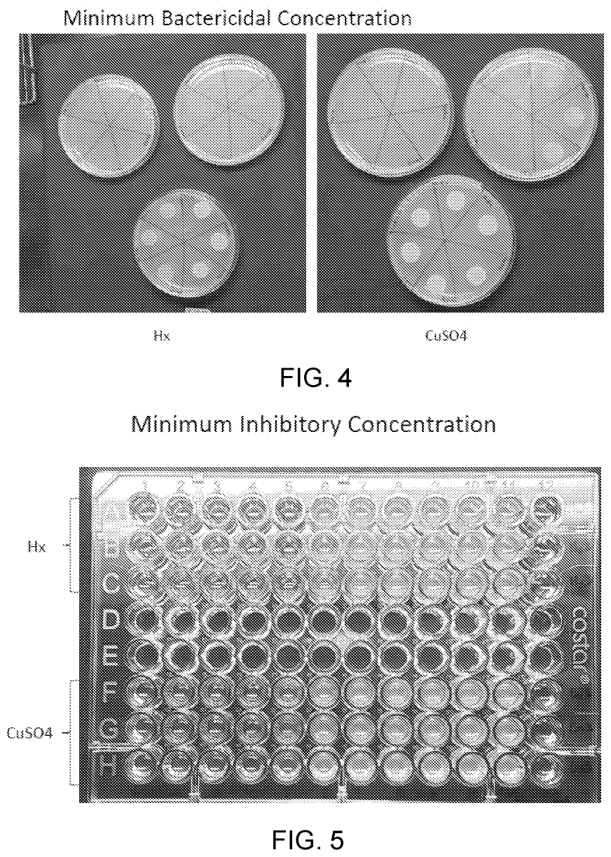

FIG. 4 is a photograph showing culture plates screening for minimum bacterial concentration (MBC) of X. perforans utilizing hexanoic acid (Hx) and copper (CuSO₄) treatments. Plates treated with hexanoic acid (Hx) can be seen on the left, whereas plates treated with copper can be seen on the right.

FIG. 5 is a photograph showing multi-well culture plates screening for minimum inhibitory concentration (MIC) of hexanoic acid (Hx) and copper (CuSO₄) treatments treatments against X. perforans. Columns 1-10 are a 2-folid dilution from 8192 to 16 mg/L, column 11 is nutrient broth plus X. perforans, and column 12 is nutrient broth only.

### Greenhouse Experiments

For the in planta study in the greenhouse, three rates of Hx (70, 512 and 1024 mg/L); Kocide® 3000, Kocide® 3000+Penncozeb® (at above mentioned rates), and an untreated control (SDW) were used. ‘Bonnie Best’ tomato seed were planted for seedlings in trays and the seedlings were transplanted to larger pots 3 weeks after seeding. The plants were then moved to a growth chamber with temperature at 28° C., 12 h photoperiod and 80% relative humidity. Fifty mL of Hx at the tested rates were applied to 3-4 weeks old plants by soil drench, 4 and 2 days prior to bacterial inoculation to prime the plants and induce basal plant defense. Kocide® 3000 and a mixture of Kocide® 3000+Penncozeb® were sprayed on the tomato plants until runoff and allowed to air dry for 4 h before bacterial inoculation. Three plants were sprayed with SDW only, as a negative control. The X. perforans GEV-485 suspension (5.0×10⁸ CFU/ml) was sprayed onto both sides of the plant leaves and whole plants were covered with plastic bags to ensure high humidity. The plants were 4 weeks old at the time of inoculation. Plastic bags were carefully removed three days post inoculation, and plants remained in the growth chamber for 24 h and then moved to greenhouse. In the greenhouse, the plants were exposed to natural photoperiod and were irrigated daily using garden hose, avoiding wetting the foliage. Disease severity and phytotoxicity were evaluated every other day using the Horsfall-Barratt scale (Horsfall and Barratt, 1945), starting from 3 days up to 20 days post inoculation. Three experiments were performed, and each treatment consisted of three replicates.

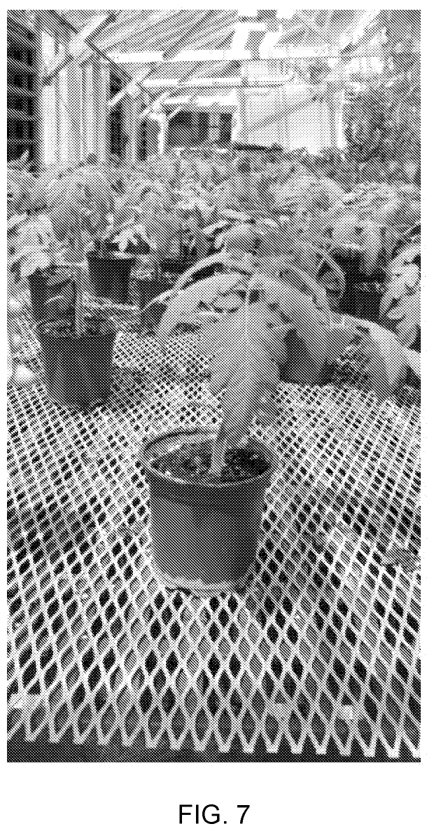

FIG. 7 is a photograph showing a tomato plant as utilized in the in planta greenhouse experiments of the present disclosure, where the soil was drenched with 50 mL of control or treatment solutions.

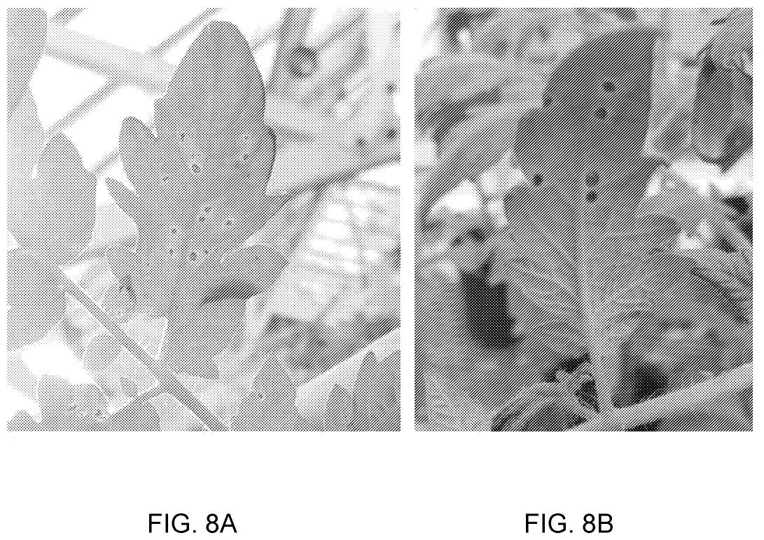

FIGS. 8A-8B are photographs of tomato leaves showing bacterial spot lesions caused by X. perforans bacterial infection.

### Statistical Analysis

All the statistical analyses were done using IBM SPSS Statistics software (version 22; Armonk, NY) or the SAS Statistical software Version 9.4 (SAS Institute Inc., Cary, NC). The in vitro and greenhouse data were collected and analyzed by analysis of variance (ANOVA) for significant differences between groups, followed by pairwise comparison using the post-hoc test method Student-Newman-Keuls (SNK) with a P value of 0.05. Means of disease severity and AUDPC were separated using Fisher's protected LSD (P=0.05).

### Results

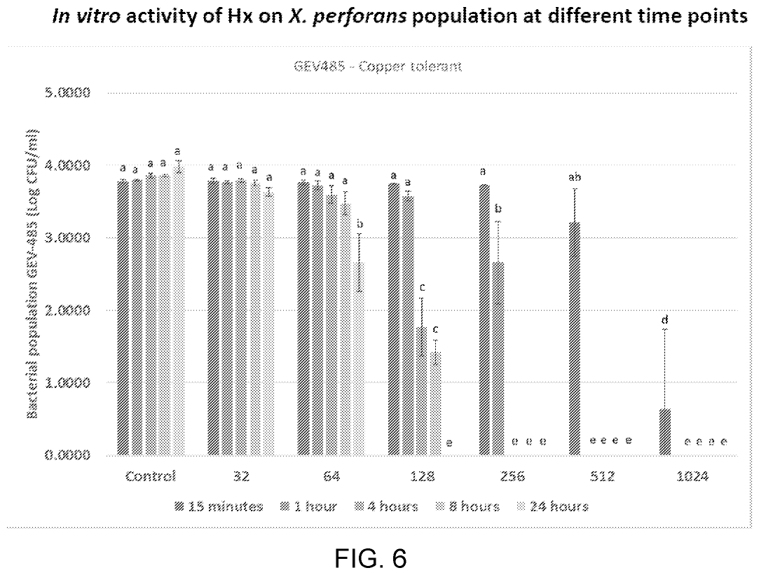

FIG. 6 is a graph of in vitro activity of Hx on X. perforans population at different time points with control or various concentrations (mg/L) of hexanoic acid treatment, plotting bacterial population (GEV-485 strain) against treatment (error bars are standard deviation). It was noted that higher concentrations of hexanoic acid had bactericidal effects within an hour. At 256 mg/L or higher concentrations, no colonies grew after 4 hours of hexanoic acid treatment.

TABLE 2
In vitro hexanoic acid and copper results showing
MIC and MBC values for three trials.

| Treatment | MIC (mg/L) | MBC (mg/L) |
|---|---|---|
| Hexanoic Acid | 512 | 1024 |
| Copper (CuSO₄) | 1024 | 2048 |

TABLE 3
Hexanoic Acid Field Trial Results

| | Experiment 1 | | | Experiment 2 | | |
|---|---|---|---|---|---|---|
| | BS1 | | YIELD1 | BS2 | | YIELD2 |
| Treatment | (%) | AUDPC1 | (Kg/plant) | (%) | AUDPC2 | (Kg/plant) |
| CK | 19.0 a | 212.6 a | 6.93 b | 49.4 a | 560.3 a | 2.85 a |
| KOCIDE ® | 15.6 b | 136.8 b | 7.78 ab | 46.3 ab | 475.0 b | 2.74 a |
| MANKO | 13.1 c | 122.0 b | 7.07 b | 44.2 bc | 441.0 b | 2.72 a |
| HEXANO | 10.8 d | 95.93 c | 8.83 a | 41.3 c | 390.1 c | 2.76 a |
| LSD_{0.05} | 1.9 | 24.3 | 1.35 | 4.7 | 46.8 | 0.53 |

Table 3 notes: Data from 2 repeated field experiments: BS1/BS2=bacterial disease severity in Exp. 1/Exp. 2; AUDPC1/AUDPC2=area under the disease progress curve in Exp. 1/Exp. 2; YIELD 1/YIELD 2=fruit yield (Kg/plant) in Exp/1/Exp.2; KOCIDER=Kocide® 3000 (Cu bactericide) at 1.75 lb/acre (=2.1 mg/mL) by sprays; MANKO=Mankocide® (Cu+mancozeb) at 1.75 lb/acre by foliar spray; HEXANO=hexanoic acid at 0.5 mg/mL (=500 mg/L) by root drench weekly for a total of 8 weeks.

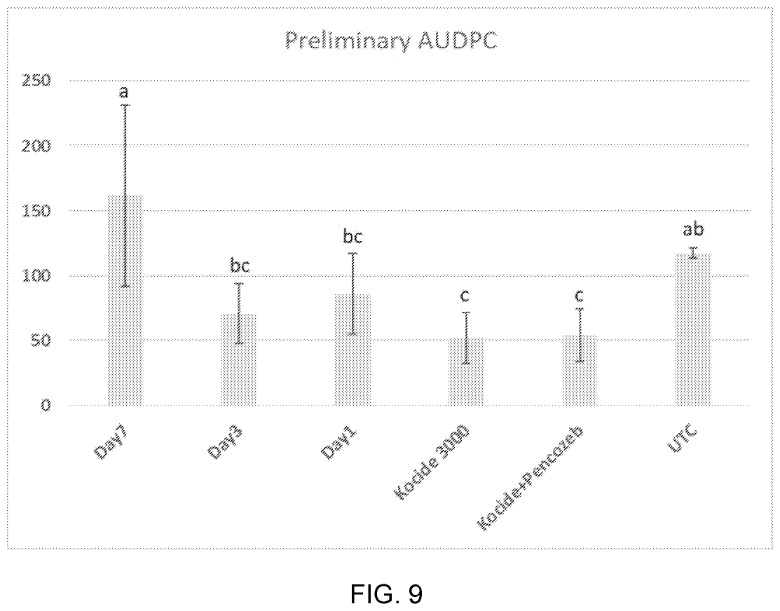

It is noted regarding the table above that: (1) data in this table were from 2 repeated field experiments, whereas those in FIG. 9 were from a greenhouse preliminary test; and (2) in the field experiments, Hx at 500 mg/L was weekly applied as soil drench for a total of 8 weeks. In the greenhouse test (FIG. 9), Hx at 512 mg/L was applied only one time as soil drench at 1, 3, or 7 days prior to the bacterial inoculation, respectively.

FIG. 9 is a plot of preliminary greenhouse screening showing the effect (preliminary AUDPC) of control, hexanoic acid (Hx), Kocide® 3000, or Kocide®+Penncozeb® combinatorial treatment against the development of bacterial spots on tomato plants in planta. A concentration of 512 mg/L was used and error bars represent standard deviation.

These data in FIG. 9 above represent results from in the greenhouse for Hx at 512 mg/L applied only once at 1, 3, or 7 days prior to the bacterial inoculation. Treatments of Kocide® 3000, Kocide®3000+Penncozeb® are statistically significantly (p<0.05) different compared to the control (UTC). However, hexanoic acid applied 1, 3, and 7 days prior to the bacterial inoculation did not appear to significantly reduce the bacterial spot disease in this preliminary test in a statistically significant manner compared to the control (UTC).

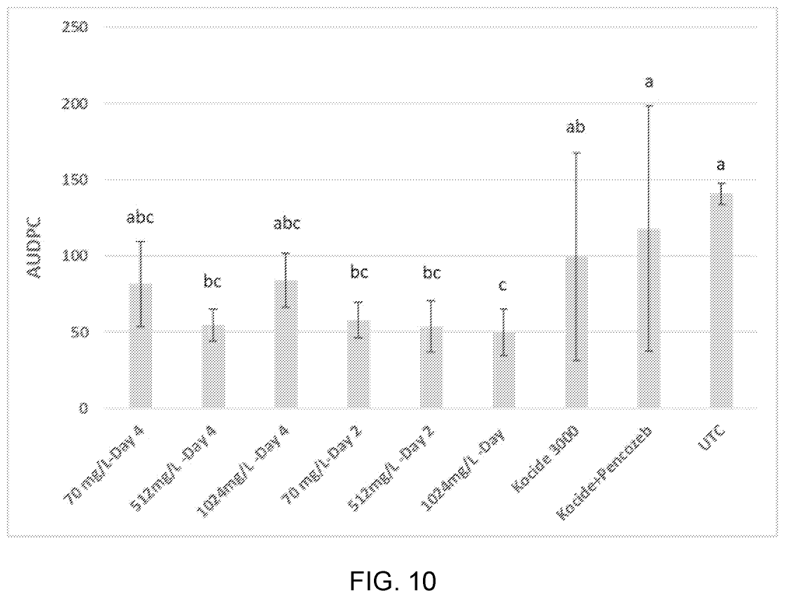

FIG. 10 is a plot of AUDPC vs. treatment showing the effect of hexanoic acid on the development of tomato bacterial spot in planta in the greenhouse. Error bars are standard deviation. At different treatment concentrations, application of hexanoic acid at two days prior to the bacterial inoculation resulted in significantly (P<0.05) lower disease severity, compared to the control, over a two-week rating period.

### Example 4

### Overall Procedures of Field Trials

Tomato seedlings were transplanted in fall for the first trial (trial 1) and spring for the second trial (trial 2). Treatments were started about two weeks after transplanting following weekly applications for a total of eight weeks. Tomato plants were inoculated with the pathogen Xanthomonas perforans (1-5×10⁶ cfu/ml) the following day in the afternoon after the third treatment. Disease severity was rated weekly when bacterial spot symptoms were observed, and area under the disease progress curve (AUDPC) was calculated. Tomato fruit were harvested two to three times for each trial and graded according to the USDA standard. Total fruit yield in each treatment and the untreated control (CK) was subjected to statistical analysis using SAS (version 9.2, SAS Institute Inc., Cary, NC, USA). Disease severity of last rating and AUDPC from each trial were analyzed and presented.

### 1. Field Trials on Hexanoic Acid:

Hexanoic acid at 0.5 mg/ml was drenched (50 ml/plant) to the base of each plant. This chemical was evaluated in two independent trials. Tomato cultivar was ‘Red bounty’.

Results: In the field trials conducted in Homestead, FL during 2020-2021, hexanoic acid at 0.5 mg/ml applied as root drench (50 ml/plant) significantly (P<0.05) reduced bacterial spot disease severity at the last rating and the overall disease progress (reflected by AUDPC) compared to the untreated control (CK). The effect on disease reduction by hexanoic acid was even better than ManKocide® at the label rate of 2.1 mg/ml, the standard copper fungicide for bacterial spot of tomato. Marketable tomato fruit yield was greater than the untreated control (CK) and ManKocide® in one of the two independent trials.

| | Trial 1 | | | Trial 2 | | |
|---|---|---|---|---|---|---|
| | BS | | YIELD | BS | | YIELD |
| Treatment | (%) | AUDPC | (kg/plant) | (%) | AUDPC | (kg/plant) |
| Untreated CK | 19.0 a | 212.6 a | 6.93 b | 49.4 a | 560.3 a | 2.85 a |
| ManKocide ® 2.1 mg/ml | 13.1 b | 122.0 b | 7.07 b | 44.2 b | 441.0 b | 2.72 a |
| Hexanoic acid 0.5 mg/ml | 10.8 c | 95.9 c | 8.83 a | 41.3 b | 390.1 c | 2.76 a |
| LSD_{0.05} | 1.9 | 24.3 | 1.35 | 4.7 | 46.8 | 0.53 |

Tomato cultivar in both trials = Red bounty.
BS = last rating of bacterial spot severity.
ManKocide ® at 2.1 mg/ml applied by foliar spray.

### 2. Field Trials on Piperidine and Pyrrolidine:

All treatments were applied through a foliar spray at specified concentrations. Piperidine and pyrrolidine were evaluated in two independent trials. Tomato cultivar was ‘Red bounty’ in trial 1, and ‘Varsity’ in trial 2.

Results: In field trials conducted during 2021-2022, piperidine at 64 mg/ml and pyrrolidine at 128 mg/ml applied as foliar sprays significantly (P<0.05) reduced bacterial spot disease severity at the last rating and the overall disease progress (reflected by AUDPC) compared to the untreated control (CK) in both independent trials. The effect on disease reduction by piperidine at 64 mg/ml was even better than ManKocide® at the label rate of 2.1 mg/ml, the standard copper fungicide for bacterial spot of tomato. Marketable tomato fruit yield was increased by 15.5% and 17.6% by piperidine at 64 mg/ml and 15.9% and 5.6% by pyrrolidine at 128 mg/ml, respectively, in two independent trials, compared to the untreated control (CK).

| | Trial 1 | | | Trial 2 | | |
|---|---|---|---|---|---|---|
| | BS | | YIELD | BS | | YIELD |
| Treatment | (%) | AUDPC | (kg/plant) | (%) | AUDPC | (kg/plant) |
| Untreated CK | 44.2 a | 709.2 a | 3.36 a | 33.8 a | 587.7 a | 3.78 a |
| ManKocide ® 2.1 mg/ml | 44.2 a | 565.1 b | 3.62 a | 28.5 ab | 434.6 b | 4.08 a |
| Piperidine 64 mg/l | 34.6 b | 495.9 bc | 3.88 a | 23.8 b | 394.9 b | 4.38 a |
| Piperdine 64 mg/l + | 34.4 b | 551.8 bc | 3.62 a | 24.2 b | 406.9 b | 4.52 a |
| ManKocide ® 1.0 mg/ml | | | | | | |
| Pyrrolidine 128 mg/l | 31.7 b | 466.1 c | 3.95 a | 23.1 b | 401.8 b | 3.99 a |
| Pyrrolidine 128 mg/l + | 34.0 b | 496.3 bc | 3.67 a | 22.3 b | 371.9 b | 4.28 a |
| ManKocide ® 1.0 mg/ml | | | | | | |
| LSD_{0.05} | 6.5 | 91.5 | 0.63 | 6.6 | 89.7 | 0.95 |

Tomato cultivar in trial 1 = Red bounty, in trial 2 = Varsity.
BS = last rating of bacterial spot severity.

Unless defined otherwise, all technical and scientific terms used have the same meaning as commonly understood by one of ordinary skill in the art to which this disclosure belongs. Although any methods and materials similar or equivalent to those described can also be used in the practice or testing of the present disclosure, the preferred methods and materials are now described.

Embodiments of the present disclosure will employ, unless otherwise indicated, techniques of separating, testing, and constructing materials, which are within the skill of the art. Such techniques are explained fully in the literature.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1. A small molecule composition for the treatment of bacterial spot disease or bacterial speck disease in a subject in need thereof, comprising:
piperidine, pyrrolidine, hexanoic acid, or any combination thereof,
wherein the piperidine, pyrrolidine, hexanoic acid, or combination thereof, is present in an amount to treat the symptoms of bacterial spot disease or bacterial speck disease in the subject in need thereof.

2. The small molecule composition of claim 1, wherein the subject in need thereof is a plant infected or at risk for infection by a bacterium of the Xanthomonas genus or Pseudomonas syringae pv. tomato.

3. The small molecule composition of claim 1, wherein the plant is a plant of the species Solanum lycopersicum or Capsicum anuum.

4. The small molecule composition of claim 1, wherein the bacterium of the Xanthomonas genus is X. vesicatoria, X. perforans, X. euvesicatoria, or X. gardneri.

5. The small molecule composition of claim 1, wherein the bacterium of the Xanthomonas genus is X. perforans.

6. The small molecule composition of claim 1, wherein the effective amount is a concentration of about 4 mg/L to about 1024 mg/L.

7. The small molecule composition of claim 1, wherein the effective amount is a concentration of about 512 mg/L.

8. (canceled)

9. The small molecule composition of claim 1, further comprising:
an aqueous vehicle.

10-17. (canceled)

18. The small molecule composition of claim 9, wherein the aqueous vehicle is water.

19. The small molecule composition of claim 1, further comprising a copper-based bactericide.

20. The small molecule composition of claim 19, wherein the copper-based bactericide is present in an effective amount to treat the symptoms of bacterial spot disease or bacterial speck disease in the subject in need thereof.

21. The small molecule composition of claim 19, wherein the effective amount of copper-based bactericide is about 1 g/L to about 2.1 g/L.

22. The small molecule composition of claim 19, wherein the copper-based bactericide is CuSO₄, a copper hydroxide, a Kocide®, a ManKocide®, or Kocide®+Penncozeb®.

23. A method of treating or preventing bacterial spot disease or bacterial speck disease in a subject in need thereof, comprising:
administering a small molecule composition to the subject in need thereof; wherein the small molecule composition comprises piperidine, pyrrolidine, hexanoic acid, or any combination thereof, and wherein the piperidine, pyrrolidine, or hexanoic acid is present in an amount to treat the symptoms of bacterial spot disease or bacterial speck disease in the subject in need thereof.

24-26. (canceled)

27. The method of claim 23, wherein the subject in need thereof is a plant infected or at risk for infection by a bacterium of the Xanthomonas genus or Pseudomonas syringae pv. tomato.

28. The method of currently amended, wherein the plant is a plant of the species Solanum lycopersicum or Capsicum annum.

29. The method of claim 23, wherein the bacterium of the Xanthomonas genus is X. vesicatoria, X. perforans, X. euvesicatoria, or X. gardneri.

30. (canceled)

31. The method of claim 23, wherein the effective amount is a concentration of about 4 mg/L to about 1024 mg/L.

32-34. (canceled)

35. The method of claim 23, further comprising a copper-based bactericide.

36. (canceled)

37. The method of claim 35, wherein the copper-based bactericide is present in the composition at about 1 g/L to about 2.1 g/L; and wherein the copper-based bactericide is CuSO₄, a copper hydroxide, a Kocide®, a ManKocide®, or Kocide®+Penncozeb®.

38-54. (canceled)
